(19) United States
(12) Patent Application Publication
(10) Pub. No.: US 2026/0073113 A1
(43) Pub. Date: Mar. 12, 2026

(54) DATA-DRIVEN CUTOUT FOR MIXED TRANSISTOR-LEVEL AND ABSTRACT-BASED TIMING ANALYSIS

(71) Applicant: International Business Machines Corporation, Armonk, NY (US)

(72) Inventors: Xin Zhao, Hopewell Junction, NY (US); Robert John Allen, Jericho, VT (US); Derrick Merrill Smith, Round Rock, TX (US); Jeremy John Leitzen, Kasson, MN (US)

(21) Appl. No.: 18/829,374

(22) Filed: Sep. 10, 2024

(51) Int. Cl. G06F 30/3323; G06F 119/12

(52) U.S. Cl. CPC G06F 30/3323; G06F 2119/12

(57) ABSTRACT

This is an approach for data-driven cutout to support mixed transistor-level timing analysis and abstract timing analysis. The approach may include specifying a plurality of rules to parameterize a small kernel pattern. Further, the approach may include specifying one or more post-matching rules for joining the small kernel pattern matches into a full-size cutout match. The approach may include generating a plurality of timing rules for each of a specific type of a kernel. The approach may also include, identifying one or more repetitive structures and/or symmetries within the small kernel pattern match. Further yet, the approach may include stitching the small kernel matches and composing the stitched small kernel matches with a correct pin correlation to a cutout. Also, the approach may include determining the kernel timing for the composed stitched kernel matches, based on the generated timing rules.

### BACKGROUND

The present invention relates to transistor-level design, and more specifically, to mixed transistor-level timing analysis and abstract-based timing analysis.

Understanding transistor-level timing is crucial for designing efficient and reliable digital circuits. It involves analyzing the time it takes for signals to propagate through transistors, ultimately determining how fast a circuit can operate. At its core, a transistor acts like an electronically controlled switch. It can be turned "on" (allowing current flow) or "off" (blocking current flow) depending on the voltage applied to its control input (gate). This switching behavior is fundamental to digital logic operations.

Simulation of circuits involves creating models that mimic the behavior of individual components or entire circuits with computer aided design software. These models can be SPICE (Simulation Program with Integrated Circuit Emphasis), which is a widely used framework for simulating electronic circuits. Another model is Verilog-AMS (VHDL Analog Mixed-Signal): A language extension for Verilog HDL that enables analog and mixed-signal simulations. Simulations can fall into one of three categories, performance evaluation, troubleshooting, and optimization. In performance evaluation, simulations help predict a design's performance under various conditions: speed and power consumption, noise immunity and susceptibility, and interference and crosstalk. In troubleshooting, simulation-based debugging helps identify and fix issues early in the design process. Finally, in optimization, simulating different design variations, designers can optimize their designs for specific requirements, for example, performance (e.g., frequency response), power consumption, and area utilization to name a few.

### SUMMARY

Embodiment of the present invention may comprise a computer-implemented method, a computer system, and a computer program product for a data-driven cutout to support transistor level timing analysis and abstract timing analysis. Embodiments of the present invention may include specifying a plurality of rules to parameterize a small kernel pattern. Further, embodiments may include specifying one or more post-matching rules for joining the small kernel pattern matches into a full-size cutout match. Also, embodiments may include generating a plurality of timing rules for each of a specific type of a kernel. Embodiments may also include, identifying one or more repetitive structures and/or symmetries within the small kernel pattern match. Further yet, embodiments may include stitching the small kernel matches and composing the stitched small kernel matches with a correct pin correlation to a cutout. Also embodiments may include determining the kernel timing for the composed stitched kernel matches, based on the generated timing rules.

### BRIEF DESCRIPTION OF THE DRAWINGS

FIG. 1, is a block diagram depicting an exemplary computing environment, in accordance with an embodiment of the invention.

FIG. 2A is a block diagram depicting a system for data-driven cutout generation, in accordance with an embodiment of the invention.

FIG. 2B is a block diagram depicting data-driven cutout engine 200, in accordance with an embodiment of the invention.

FIG. 3 is a flowchart, depicting the steps for generating a data-driven cutout, in accordance with an embodiment of the invention.

### DETAILED DESCRIPTION

Embodiments of the present invention recognize the advantages of productive cutout methodology to support cutout variations within transistor circuit design through transistor-level timing analysis and abstract-based timing analysis. Some portions of circuits are not suitable for simulations of transistor level timing (e.g., analog circuits, sense amp, DRAM, etc…). A gray box is a timing abstract which represents a subset of a design, in the instant case, this would be circuits which are not well suited for simulations of transistor level timing. In many cases a gray box is created by specifying a hierarchical boundary, where the context of the contents is omitted from parasitic layout extraction. Gray box creation has sensitive hierarchical requirements and layout constraints, specifically, it requires a close match between schematic hierarchy and layout hierarchy. One issue with creating a gray box is that to find a hierarchical boundary a designer will increase the scope and thus the size of the gray box. This can result in miscalculating the parasitic effects related to the components within the gray box. Therefore, it would be advantageous to have flexibility in choosing the boundary for the timing abstract on a subset transistor netlist, while retaining the parasitic effects within the model to allow for analysis of the timing and ultimately allowing for generation of timing rules based on the real layout of the circuit. Parasitic capacitance refers to unwanted or unintentional capacitive effects that occur between various components and conductive paths within an electronic circuit. These unintended capacitances can be caused by the physical proximity of different parts in the design, such as wires, traces, and pins.

For a cutout (i.e., a gray box), efficient matching and correct pin correlation to the timing abstract is challenging in the presence of repetitive internal substructure. Methods include significant code development to build ad-hoc techniques, in order to create repetitions in cutout matching and the timing spec while considering the complicated matching topology and requirements to disambiguate and break symmetry in the repetitive cutout structure. Further, once a design requires changes associated with or to a cutout, updating the cutout is a time-consuming and labor-intensive process. It should be noted that computer aided design is necessary in modern timing analysis procedures as modern computer chips contain billions of transistors. This is an unavoidable requirement as humans even with the aid of pen and paper would not be able to complete the necessary tasks associated with timing analysis due to the sheer volume of transistors on a modern computer chip.

In an embodiment, decompose a full-sized cutout matching instance (e.g., a bit column) into a set of small kernel patterns (e.g., a write head, a sense amplifier, an edge cell, a 6T Cell, etc.). For example, a bit column may consist of four write head kernels, two sense amplifier kernels, and hundreds of cell kernel patterns. In an array design, there can be hundreds of matching instances, such as bit columns. Kernel patterns are smaller, repeatable structures within a larger circuit. These kernel patterns can be matched to create larger instances of the same structure, reducing the complexity of the analysis. In cutout-based timing analysis, kernel patterns correspond to specific logic gates or combinational circuits. Ultimately, the matching process involves identifying these patterns and their relationships to generate a timing model.

In an embodiment, specify rules to parameterize kernel pattern matching steps and dependencies among kernel patterns by anchoring. For example, define a sequence of kernel patterns to match in a human-readable format (such as JavaScript Object Notation (“JSON”). In an embodiment, for each kernel pattern, the pattern action section collects pattern matching data and enters the pattern matching data into corresponding structured tables. Embodiments may rely on rule-based pattern matching to grow the cutout instances from smaller kernel patterns. This approach allows for efficient analysis of repetitive structures, which may be particularly useful in transistor-level timing analysis. In an embodiment, rules can be defined to capture specific timing characteristics, such as propagation delays, setup times, and hold times, associated with single-bit cutout kernel timing. By applying these rules, an embodiment may generate a timing model that accurately reflects the behavior of the larger circuit.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

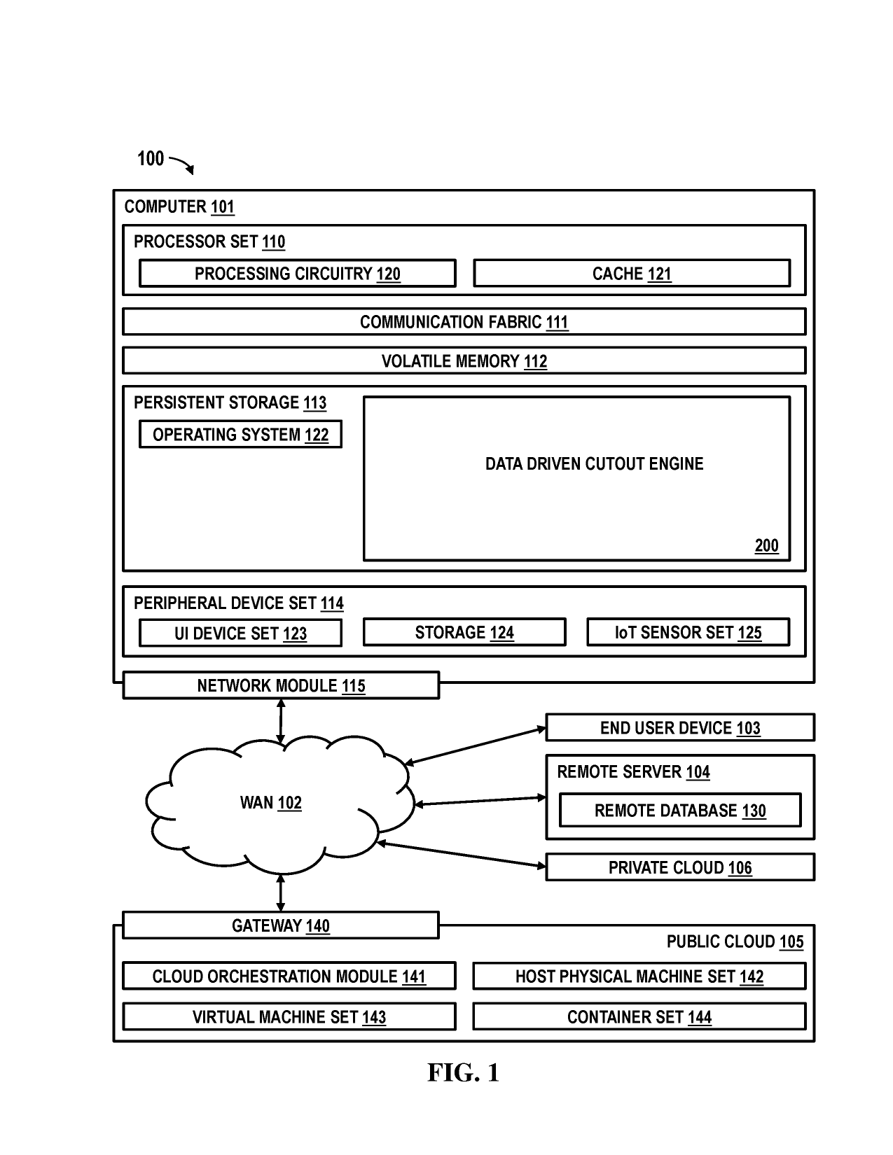

Now with reference to FIG. 1. FIG. 1 depicts Computing environment 100. Computing environment 100 contains an example of an environment for the execution of at least some of the computer code involved in performing the inventive methods, such as data-driven cutout engine 200. In addition to data-driven cutout engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data-driven cutout engine 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data-driven cutout engine 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in data-driven cutout engine 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

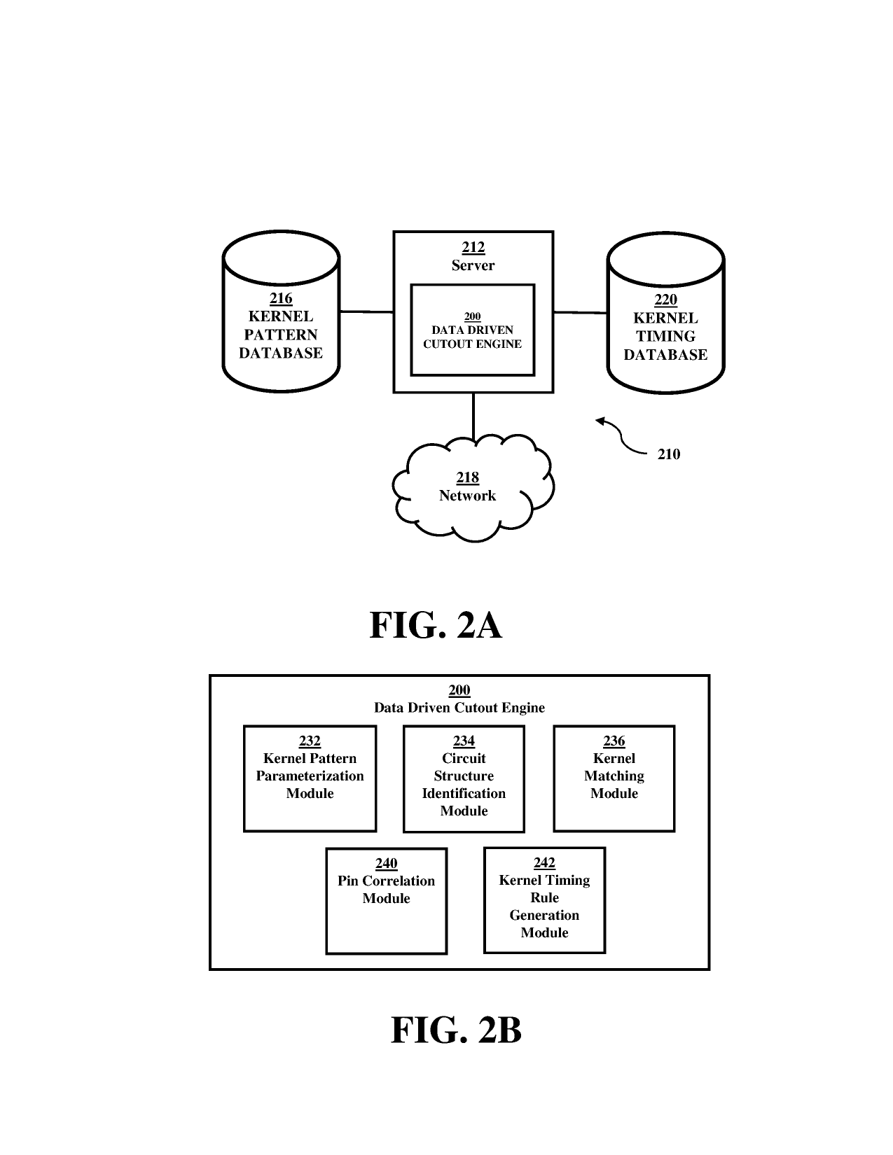

With reference now to FIG. 2A. FIG. 2A is a block diagram depicting a system for data-driven cutout generation, in accordance with an embodiment of the invention. Shown in FIG. 2A is server 212 and network 218. Shown operational on server 212 are kernel pattern database 216 and data-driven cutout engine 200.

Data-driven cutout engine 200 is a computer program that can generate cutouts from a flattened transistor level netlist. Data-driven cutout engine 200 can be a stand-alone program or a module within a computer aided design software program. In an embodiment, data-driven cutout engine 200 can have multiple functions which can be provided by one or more modules within the program. For example, data-driven cutout engine 200 can define pattern circuitry and pre-characterize the timing abstracts on the pattern circuitry. Identify subsets of an input netlist that have the same circuit topology as the predefined pattern circuit through SPAM pattern matching. Create pattern matching transistors from the input netlist replacing each matching subset with a new cutout instance and connecting the cutout instance pins to the nets. Furthermore, data-driven cutout engine 200 can determine whether to retain the parasitic properties inside the cutout or allow the parasitic properties to escape the cutout. Additionally, in an embodiment, data-driven cutout engine 200 may also load the pre-characterized timing abstracts on to cutout instances and apply transistor level simulation with an end goal of generating timing rules.

Kernel pattern database 216 is a database with predefined or preconfigured kernel patterns. Also stored on kernel pattern database 216 are historical timing abstracts related to kernel patterns and details of the parasitic properties associated with the kernel patterns.

Kernel timing database 220 is a database with historical kernel timing data. The historical data can include past timing analysis of single-bit kernels and kernel patterns. The kernel timing database 220 can include prior kernel timing pattern rules assigned to kernel patterns and developed for full-sized cutouts.

With reference now to FIG. 2B. FIG. 2B is block diagram 210 depicting data-driven cutout engine 200, in accordance with an embodiment of the invention. Shown operational on data-driven cutout engine 200 are kernel pattern parameterization module 232, circuit structure identification module 234, kernel matching module 236, pin correlation module 240 and kernel timing rule generation module 242.

Kernel pattern parameterization module 232 is a computer module that can be operational on data-driven cutout engine 200. In an embodiment, kernel pattern parameterization module 232 can receive or recognize historical kernel pattern matching rules. The rules can be associated with pattern matching steps and dependencies among kernel patterns. The rules can be in human readable format such as JSON or any other suitable format. In an embodiment, kernel pattern parameterization module 232 can also receive post matching-rules to join kernel pattern matches into full-sized cutout matches. These rules may incorporate disambiguating repetitive structures, breaking structure symmetry and/or methods and manners of correctly correlating pins.

Circuit structure identification module 234 is a computer module that can identify and recognize structures of a transistor-level circuit on a flattened netlist. In an embodiment, circuit structure identification module 234 can parse a circuit netlist and begin building a structured data table of the structures within that netlist.

Kernel matching module 236 is a computer module that can match structures identified in a netlist to the correct defined parameters within a structured data table. Further in an embodiment, kernel matching module can grow a cutout by matching a plurality of small kernel patterns. For example, a pattern of cells to a write head can be joined to generate a larger cutout with known properties ensuring a more accurate timing analysis. In the immediate example, rows of a data table can be joined i.e., the write head components may be 130 rows and the cells may be 4160 rows.

Pin correlation module 240 is a computer module that can determine the pin correlations between kernels in three dimensions, while maintaining the flattened two-dimension nature of the netlist. For example, the pin-to-net mapping can have pre-defined rules or rules from a user. Dimensions may be clustered by which cellblock the cluster belongs to and defined by specific variances. Further, the pin correlation module may contain specific rules within the netlist that define how the three-dimension expansion is to be understood.

Kernel timing rule generation module 242 is a computer module that can generate timing rules for kernels. In an embodiment, kernel timing rule generation module 242 can generate a timing rule for a single-bit cutout. In another embodiment, kernel timing rule generation module 242 can expand single-bit kernel timing rules into multi-bit full-size cutout timing rules. In the immediate embodiment, the identification of repetitive sturcutres can be utilitzed in the expansion. It should be noted, in some cases the kernel timing is not requied to be a one-to-one mapping to the reference kernel pattern and can be based on historically known kernel timings (e.g., from kernel timing database 220). In another embodiment, kernel timing rule generation module 242 can expand the kernel timing rules to include one or more characteristics associated with the kernel(s) (e.g., power consumption, noise, materials, etc).

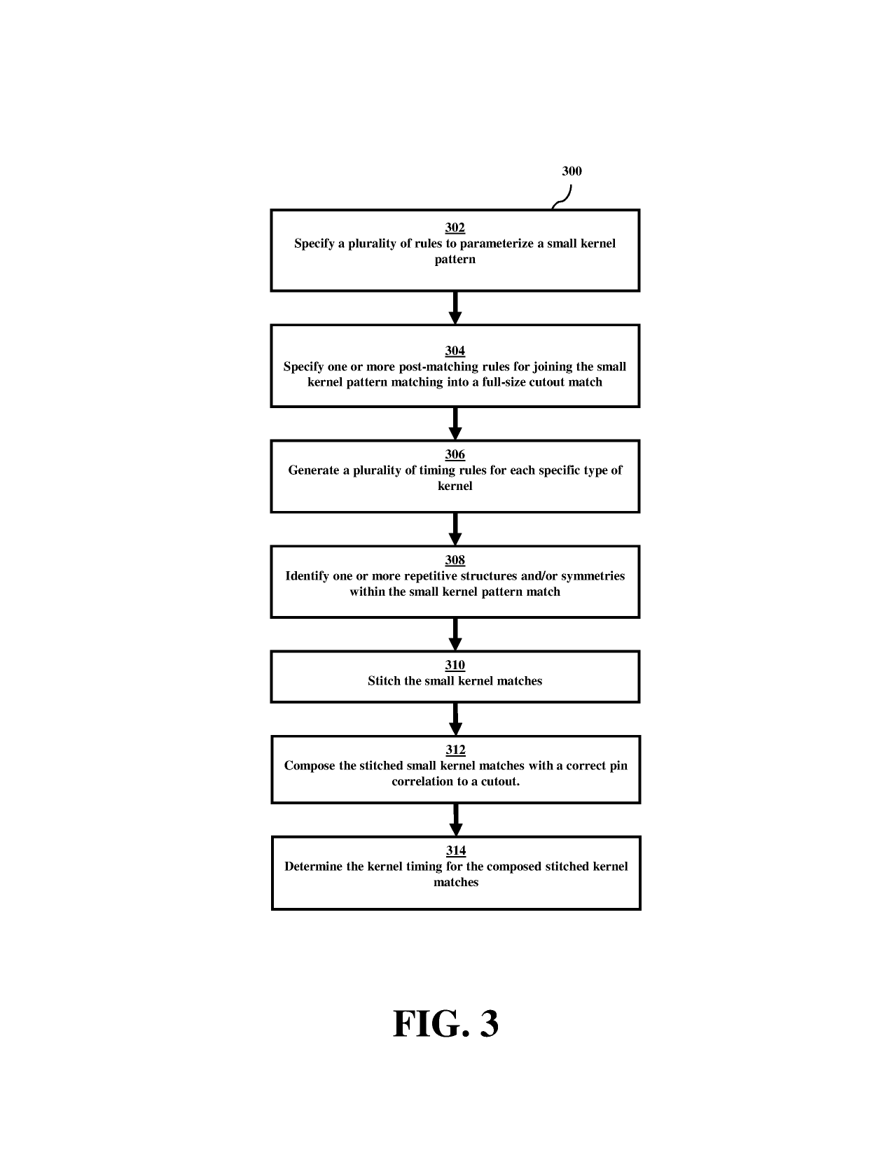

With reference now to FIG. 3. FIG. 3 is flowchart 300 depicting the steps for generating a data-driven cutout. At step 302, kernel pattern parameterization module 232 specifies a plurality of rules to parameterize a small kernel pattern. At step 304, circuit structure identification module 234 specifies one or more post-matching rules for joining the small kernel pattern matching into a full-size cutout match. At step 306, kernel timing rule generation module 242 generates a plurality of timing rules for each specific type of kernel. At step 308, kernel matching module 236 identifies one or more repetitive structures and/or symmetries within the small kernel pattern mach. At step 310, kernel matching module 236 stitches the small kernel matches. At step 312, pin correlation module 240 compose the stitched small kernel matches with a correct pin correlation to a cutout. At step 314, kernel timing rule generation module 242 determines the kernel timing for the composed stitched kernel matches.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-method for cutout methodology to support cutout variations within transistor-level and abstract-based timing analysis, the computer-implemented method comprises:
specifying a plurality of rules to parameterize a small kernel pattern;
specifying one or more post-matching rules for joining the small kernel pattern matches into a full-size cutout match;
generating a plurality of timing rules for each of a specific type of a kernel;
identifying one or more repetitive structures and/or symmetries within the small kernel pattern match;
stitching the small kernel matches;
composing the stitched small kernel matches with a correct pin correlation to a cutout; and
determining the kernel timing for the composed stitched kernel matches, based on the generated timing rules.

2. The computer-implemented method of claim 1, further comprises:
decomposing a full-size cutout matching instance into the set of small kernel patterns.

3. The computer implemented method of claim 1, wherein specifying the rules to parameterize the small kernel patterns further comprises:
matching one or more steps and associated dependencies among the small kernel patterns based on anchoring.

4. The computer implemented method of claim 1, wherein specifying the one or more post-matching rules further comprises:
discovering repetition structure within the small kernel patterns.

5. The computer-implemented method of claim 1, wherein determining kernel timing further comprises:
applying the identified repetitive structure as rules to increase a kernel timing abstract from a single bit to a full-sized multi-bit cutout timing abstract.

6. The computer implemented method of claim 1, wherein specifying the rules to parameterize the small kernel patterns further comprises:
collecting pattern matching data into one or more structured data tables.

7. The computer-implemented method of claim 1, further comprises:
disambiguate the identified repetitive structure and break identified symmetries.

8. The computer-implemented method of claim 1, wherein composing the stitched small kernel matches with a correct pin correlation to a cutout further comprises:
expanding the cutout to a multi-dimension mapping.

9. The computer-implemented method of claim 1, wherein the plurality of rules to parameterize a small kernel pattern are programmed in JavaScript Object Notation.

10. A computer system for supporting cutout variations within transistor-level and abstract-based timing analysis, the computer system comprises:
a memory; and
a processor in communication with the memory, the processor being configured to perform operations to:
specify a plurality of rules to parameterize a small kernel pattern;
specify one or more post-matching rules for joining the small kernel pattern matches into a full-size cutout match;
generate a plurality of timing rules for each of a specific type of a kernel;
identify one or more repetitive structures and/or symmetries within the small kernel pattern match;
stitch the small kernel matches;
compose the stitched small kernel matches with a correct pin correlation to a cutout; and
determine the kernel timing for the composed stitched kernel matches, based on the generated timing rules.

11. The computer system of claim 10, further comprises:
decompose a full-size cutout matching instance into the set of small kernel patterns.

12. The computer system of claim 10, wherein specifying the rules to parameterize the small kernel patterns further comprises:
match one or more steps and associated dependencies among the small kernel patterns based on anchoring.

13. The computer system of claim 10, wherein specifying the one or more post-matching rules further comprises:
discover repetition structure within the small kernel patterns.

14. The computer system of claim 10, wherein determining kernel timing further comprises:
apply the identified repetitive structure as rules to increase a kernel timing abstract from a single bit to a full-sized multi-bit cutout timing abstract.

15. The computer system of claim 10, wherein specifying the rules to parameterize the small kernel patterns further comprises:
collect pattern matching data into one or more structured data tables.

16. The computer system of claim 10, further comprises:
disambiguate the identified repetitive structure and break identified symmetries.

17. The computer system of claim 10, wherein composing the stitched small kernel matches with a correct pin correlation to a cutout further comprises:
expand the cutout to a multi-dimension mapping.

18. The computer system of claim 10, wherein the plurality of rules to parameterize a small kernel pattern are programmed in JavaScript Object Notation.

19. A computer program product for supporting cutout variations within transistor-level and abstract-based timing analysis, the computer program product comprising a computer storage device, and program instructions stored on the computer storage device, wherein the program instructions comprise:
program instructions to specify a plurality of rules to parameterize a small kernel pattern;
program instructions to specify one or more post-matching rules for joining the small kernel pattern matches into a full-size cutout match;
program instructions to generate a plurality of timing rules for each of a specific type of a kernel;
program instructions to identify one or more repetitive structures and/or symmetries within the small kernel pattern match;
program instructions to stitch the small kernel matches;
program instructions to compose the stitched small kernel matches with a correct pin correlation to a cutout; and
program instructions to determine the kernel timing for the composed stitched kernel matches, based on the generated timing rules.

20. The computer program product of claim 19, further comprising:
program instructions decompose a full-size cutout matching instance into the set of small kernel patterns.
